(19) United States
(12) Patent Application Publication
(10) Pub. No.: US 2006/0248051 A1
(43) Pub. Date: Nov. 2, 2006

(54) System and method for managing search display windows

(75) Inventor: Brian R. Meyers, Bellevue, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation, Redmond, WA (US)

(21) Appl. No.: 11/117,806

(22) Filed: Apr. 29, 2005

(51) Int. Cl. G06F 17/30

(52) U.S. Cl. 707/3

(57) ABSTRACT

A system and a method for managing the display of content associated with a subset of an ordered list of objects are provided. The method includes obtaining an ordered list of objects, such as from executing a search tool. The method includes displaying at least a subset of the ordered list; and the method includes displaying content associated with the subset of the ordered list in a plurality of display windows corresponding to an available display space.

### FIELD OF THE INVENTION

The present invention is related to a method and a system for managing a display area and displaying content from multiple objects from a list, in multiple windows.

### BACKGROUND OF THE INVENTION

Traditional searching tools, such as desktop or Internet search tools, typically generate a list of objects ranked according to some algorithm containing only minimal textual information that includes a link to the object. If the search tool is an Internet search engine, the results are displayed in an ordered list that can include multiple pages containing the search results. The content provided in the ordered list is minimal and rarely provides enough information to determine whether the user may be interested in the object. To view more content, the user can move a pointer over a link to the object, click on the link, and the Web site to such link will open. Typically, the Web site will occupy all the display area of a computer. If the Web site is not interesting to the user, the user must return to the search results page, typically by clicking on a Web browser back browse button and selecting a different link, involving again moving the pointer over the link, and clicking on the link to see whether the content of the newly selected Web site is more appropriate for his or her needs. Again, if the user is disappointed with the content of the Web site, the user must again click on the Web browser back browse button to return to the page having the ordered list of links and continue trying more links until the Web site that most closely matches the user's interest is reached. As can be quickly appreciated, “surfing” through the various links by sequentially navigating to each individual Web site can quickly become a time-consuming and tedious task, especially for users of smaller computing devices having generally smaller display screens, such as mobile cellular phones.

Accordingly, there is a need to be able to display contents of objects in an ordered list that currently only provide minimal textual information.

### SUMMARY OF THE INVENTION

The present invention is related to a system and a method for managing the display of content associated with a subset of an ordered list of display objects. The method includes obtaining an ordered list of display objects, such as from executing a search tool. The method includes displaying at least a subset of the ordered list; and the method includes automatically displaying content associated with the subset of the ordered list in a plurality of display windows corresponding to an available display space.

In another aspect of the present invention, a method for managing the display of content is provided that includes obtaining an ordered list of display objects and automatically displaying content associated with a subset of the ordered list in a plurality of display windows corresponding to an available display space.

In another aspect of the present invention, a search system is provided that includes a search engine; and a module for managing search display windows, including displaying the content of display objects obtained by the search engine in a plurality of display windows.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a diagrammatical representation of a multiple display area, according to one embodiment of the invention;

FIG. 2 is a diagrammatical representation of FIG. 1 illustrating a display of content from an ordered list in multiple windows, according to one embodiment of the present invention;

FIG. 3A is a diagrammatical representation of FIG. 1 illustrating the management of content from an ordered list displayed in multiple windows, according to one embodiment of the present invention;

FIG. 3B is a diagrammatical representation of FIG. 1 illustrating the management of content from an ordered list displayed in multiple windows, according to one embodiment of the present invention;

FIG. 4 is a diagrammatical representation of FIG. 1 illustrating the display of visual aids for selecting content displayed in multiple windows, according to one embodiment of the present invention;

FIG. 5 is a diagrammatical representation of FIG. 1 illustrating the display of content in multiple windows in conjunction with a separate computing device, according to one embodiment of the present invention;

FIG. 6 is a flow diagram of a method for managing windows in a display area, according to one embodiment of the present invention; and

FIG. 7 is a diagrammatical representation of variable sized windows in a display area for displaying content from an ordered list, according to one embodiment of the present invention.

### DETAILED DESCRIPTION OF THE PREFERRED EMBODIMENT

The present invention relates to a system and method for managing windows and a display space to display the contents of one or more objects from a list of objects. As is generally well known, Internet search engines, and search tools in general, result in an ordered list of targets that may be manipulated by a user. The ordered list is generally hierarchically ranked according to an algorithm that applies some ordering criteria, such as relevancy, time, file type, etc. The present invention provides content arranged within multiple windows in a display space to apprise the user of the contents of the search targets without the user having to navigate to each search target individually. Although the present invention will be described with regard to illustrative user interfaces and displays, one skilled in the relevant art will appreciate that the disclosed embodiments are illustrative and should not be construed as limiting.

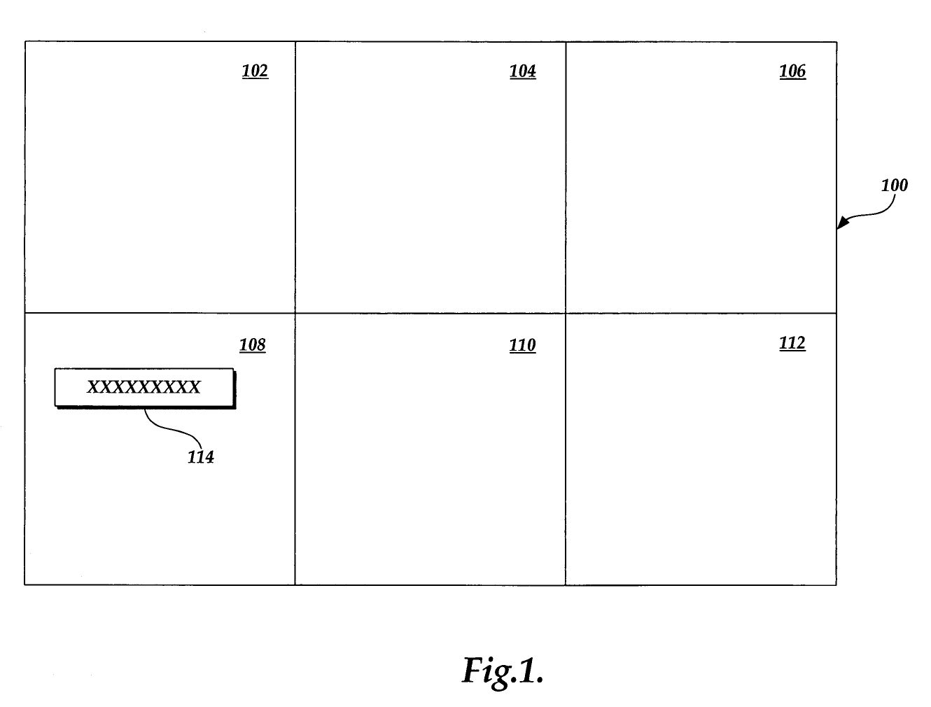

Referring to FIG. 1, a display, such as may be provided on a personal computer, occupying a defined display space 100, is illustrated. The display has a defined apportionable display space that may be apportioned into any number and size of display windows. While the present invention may be discussed in the context of graphical windows, it is not to be construed as limiting the invention to a windowing environment. The use of windows to describe the present invention merely represents one exemplary embodiment of the invention. Furthermore, the display space 100 may be extended across any number of physical displays, such that one or more windows can be displayed across one or more displays. In one embodiment, the display space 100 includes the windows 102, 104, 106, 108, 110, and 112. Although not expressly shown, it is to be appreciated that windows may have the customary controls associated with windows in a windowing environment. Each window 102, 104, 106, 108, 110, and 112 may be apportioned an equal amount of the total display space 100 of the physical display to utilize the entire space of the display. A search tool having a search string field 114, ready to be executed, is currently displayed in the window 108. Window 108 may be referred to herein as the “base search” window that includes the interface to a search tool. Windows 102, 104, 106, 110, and 112 are currently empty. Windows 102, 104, 106, 110, and 112 may be initially absent from the display space 100, and may only appear until after a search has been executed and the search has retrieved the search result targets. Furthermore, the number of windows that may be created may be dependent on the number of search targets that are obtained from running the search. For example, if the search resulted in two search targets, then, two windows may be created. If the search resulted in a large number of search targets, then, a larger number of smaller windows may be created. The discussion herein with respect to the number of display windows is intended to be for illustration purposes only, and is not to be construed as limiting the invention to any one particular embodiment.

In an illustrative embodiment, a search system having a search engine and a module to execute a method for managing multiple display windows is running in the background. The search engine and module may reside in the same computing system as the display or in a different computing system (connected via a network connection). According to other embodiments, the module may be implemented as software or logic, within one or more components of the computer system. In other embodiments, the module may be implemented as one or more software modules operating in conjunction with, or as part of, the operating system, or as part of a software application installed on the computer system. Accordingly, the module should not be construed as limited to any one particular embodiment. Furthermore, although the present invention may be discussed in the context of search tools, it is to be appreciated such use is merely for describing one embodiment of the invention. The present invention may be used with a list of objects wherein the content of the objects may be displayed. Objects may include URL's (Uniform Resource Locator), any file types, and the like.

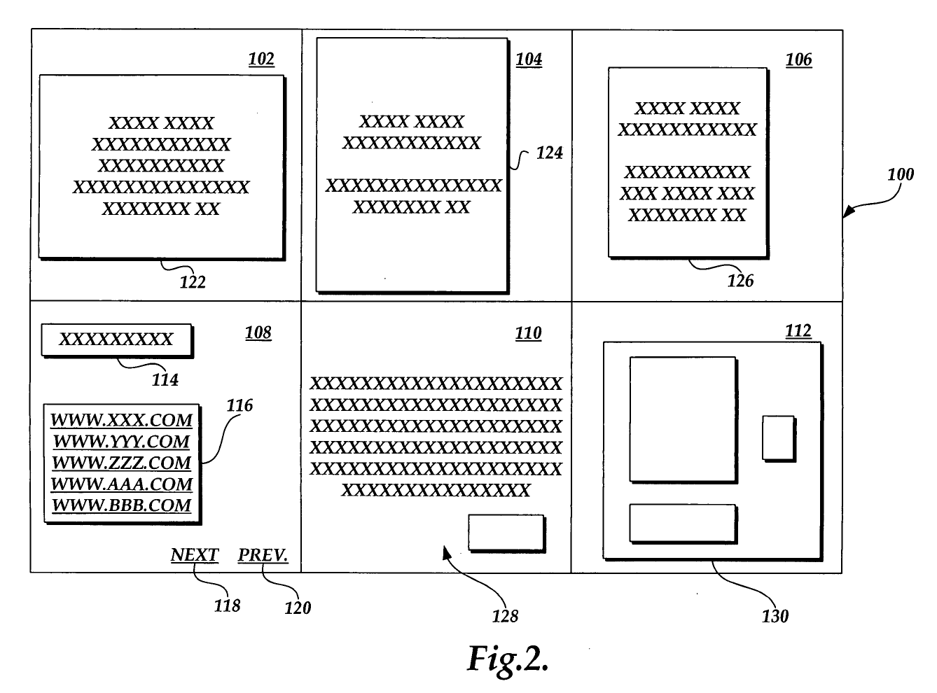

Referring now to FIG. 2, a search has been executed for the search string provided within the search field 114 of the search tool and has resulted, at least, in an ordered list of objects. At least a subset of the ordered list is displayed in an area of window 108 within the subwindow 116 as manipulatable data objects, such as hyperlinks, files, or icons. Window 108 may also include some user navigation controls for accessing different pages including more display objects from the ordered list, and for saving one or more display objects for later recall. For example, window 108 may include the next page browse button 118 and the previous page browse button 120. Next page browse button 118, when selected, scrolls the objects of the subwindow 116 to a next subset of display objects from the ordered list. Previous page browse button 120, when selected, scrolls to the previous subset of display objects.

For purposes of an illustrative example, subwindow 116 shows five search targets each appearing as a link to a specific Web site associated with such link. Windows 102, 104, 106, 110, and 112 have now been populated with content. Each multiple window 102, 104, 106, 110, and 112 may be arranged to correspond to the hierarchy of the ordered list in subwindow 116. For example, in one embodiment, the most relevant display object is placed at the top of the list, and search targets are arranged in decreasing order of relevance. In another embodiment, the order of the display objects may correspond to paid sponsorships. When working with multiple windows of the present invention, the content corresponding to the topmost display object may be located in the upper left hand window 102 of the display space 100. The content corresponding to the next display object can be located adjacent and to the right of window 102 in window 104. When there is no more available display space on the top row, the content of subsequent display objects can be placed at the left most position, assuming not already taken up by the base search window, and immediately below the upper row of windows. One skilled in the relevant art will appreciate that the present invention may be utilized in conjunction with various alternative display configurations. For example, the windows 102-112 may be configured in a circular pattern to highlight a control window.

In an illustrative embodiment of the present invention, only five windows are populated with content from search targets, since subwindow 116 also only has five search targets. However, other embodiments of the invention may result in providing more or less windows than correspond to the displayed search targets. In the example provided, the link “WWW.XXX.COM” is the most relevant search target because this link appears at the top of the displayed list. Accordingly, the content that would appear if one were to navigate to the link “WWW.XXX.COM” is the content 122 provided within window 102. In this example, the link “WWW.YYY.COM” is the second most relevant object because this link is second from the top of the list. Therefore, content associated with “WWW.YYY.COM” appears as content 124 and is located in window 104, and so on for the remaining search targets in subwindow 116. Content 126 corresponds to the link “WWW.ZZZ.COM” and is displayed in window 106. Content 128 corresponds to the link “WWW.AAA.COM” and is displayed in window 110. Content 130 corresponds to the link “WWW.BBB.COM” and is displayed in window 112.

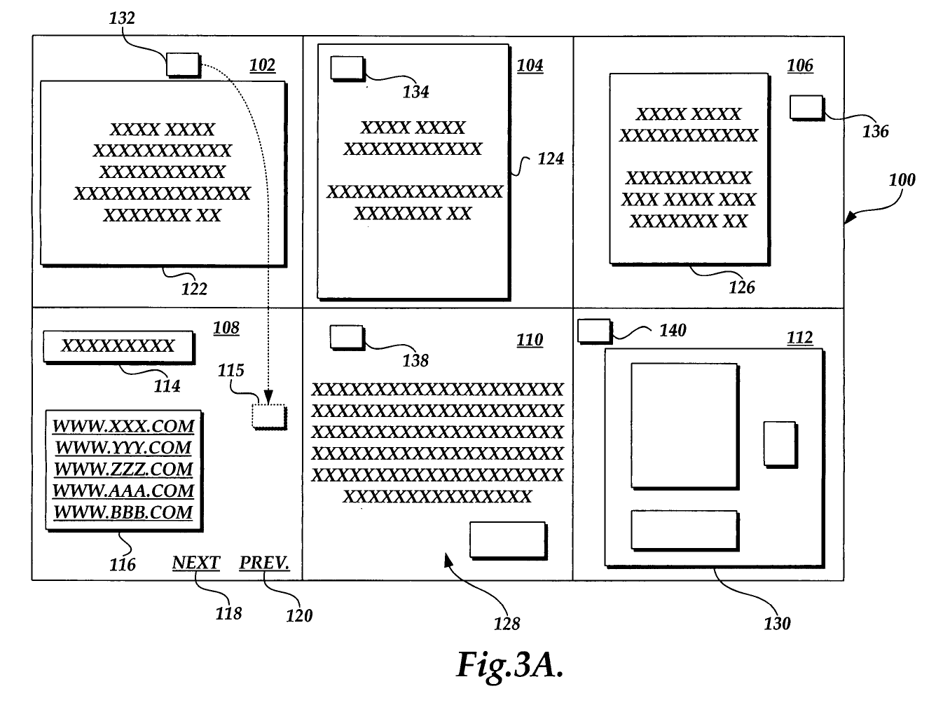

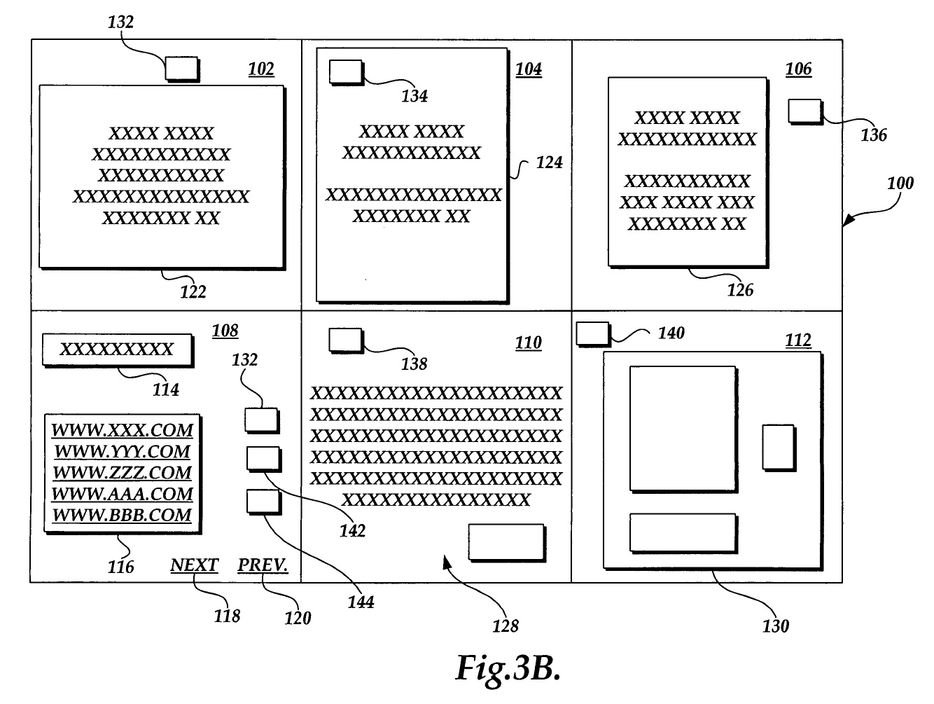

Referring now to FIG. 3A, another aspect of the present invention is illustrated. The base search window 108 may include an area defined herein as a “basket,” wherein search target links to favorite Web sites may be stored for later access. For example, if the user were to browse through the search targets in the subwindow 116, the user may want to save one or more of the search target links to more quickly recall the content of the various Web sites for future reference. The user can store the favorite search target links and the contents by selecting a drag and drop control located in any one of the windows 102, 104, 106, 110, and 112. For example, in the window 102, drag and drop control 132 may be selected, dragged, and dropped into basket 115 in window 108. Once placed in the basket, the drag and drop control 132 may be hidden from view until a user opens the basket. The user may recall the content 122 specifically associated with the drag and drop control 132 at a later time by selecting the drag and drop control 132 from the basket 115 in window 108. As illustrated in FIG. 3A, each window 104-112 also has a drag and drop control 134-140 associated with content. In an illustrative embodiment of the present invention, the drag and drop control can take several forms manipulatable by a user. Additionally, the drag and drop control can include thumbnail images and/or textual descriptions corresponding to the content. In one embodiment, a thumbnail image for any display window can be placed in the basket by dragging and dropping the thumbnail image into the basket 115.

With reference now to FIG. 3B, another embodiment of displaying drag and drop controls is illustrated, wherein the drag and drop controls 132, 142, and 144, are displayed within an area of window 108. A user may recall content by selecting any of the drag and drop controls within the area of the window 108. If a user selects a drag and drop control not associated with any content currently being displayed, for example, selecting either drag and drop control 142 or 144, the content corresponding to the selected drag and drop control may be generated on one of the display windows 102-112. In other embodiments, after selecting to open a drag and drop control, such as a thumbnail image of a display window, the content associated with the selected drag and drop control may be displayed across the entire display space 100. Additionally, the drag and drop controls 132, 142, and 144 do not need to correspond to the same type of content.

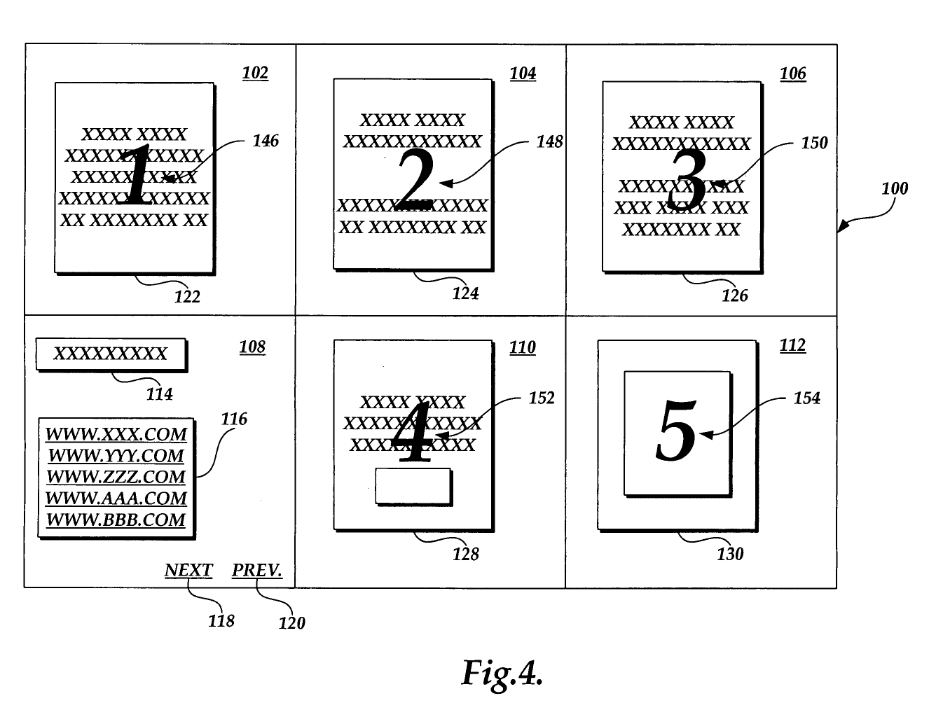

Referring now to FIG. 4, a further aspect of the present invention is illustrated. Each of the windows 102, 104, 106, 110, and 112 has a numerical schema for a user to access, manipulate, and navigate to content. For example, window 102 has numerical schema “1” (146), window 104 has numerical schema “2” (148), window 106 has numerical schema “3” (150), window 110 has numerical schema “4” (152), and window 112 has numerical schema “5” (154). Accordingly, numerical schema 146 is associated with content 122. Numerical schema 148 is associated with content 124. Numerical schema 150 is associated with content 126. Numerical schema 152 is associated with content 128. Numerical schema 154 is associated with content 130. One example of using numerical schema to manage content may be as follows. The user has selected to move on to the next subset of search targets in subwindow 116 by selecting the next page browse button 118. Upon selecting the next page browse button 118, the content in windows 102, 104, 106, 110, 112 will be replaced by the content associated with the new subset of search target links that will appear in the subwindow 116. The new subset of links and the contents may have new numerical schema “6” through “10.” However, if the user wanted to recall a particular content from the previous subset without the use of the previous page browse button 120, the user may alternatively select to simply type in the numerical schema of the particular content which is of interest to him. This selection operation may be done by the user via a voice, keyboard, or other input device. The numerical schema may be located anywhere in the base search window 108 as numerical visual cues. Thus, numerical schema provide an alternate way for the user to quickly navigate to any content of a previous or current display window. Furthermore, as with the earlier described embodiment, if a particular numerical schema is selected, the content that is associated with the selected numerical schema may be displayed across only one of the plurality of display windows, or across the entire display space 100, or any amount of display space in between. Selecting a numerical schema may also be used as an alternative to a drag and drop operation to store thumbnail images of entire display windows within basket 115 of the earlier embodiment. Additionally, the numerical schema may reset with each subset of links to allow users to save content by selecting a corresponding numerical schema. Although the present invention is discussed in the context of numerical schemas, the use of numerical schemas should not be construed as limiting the invention.

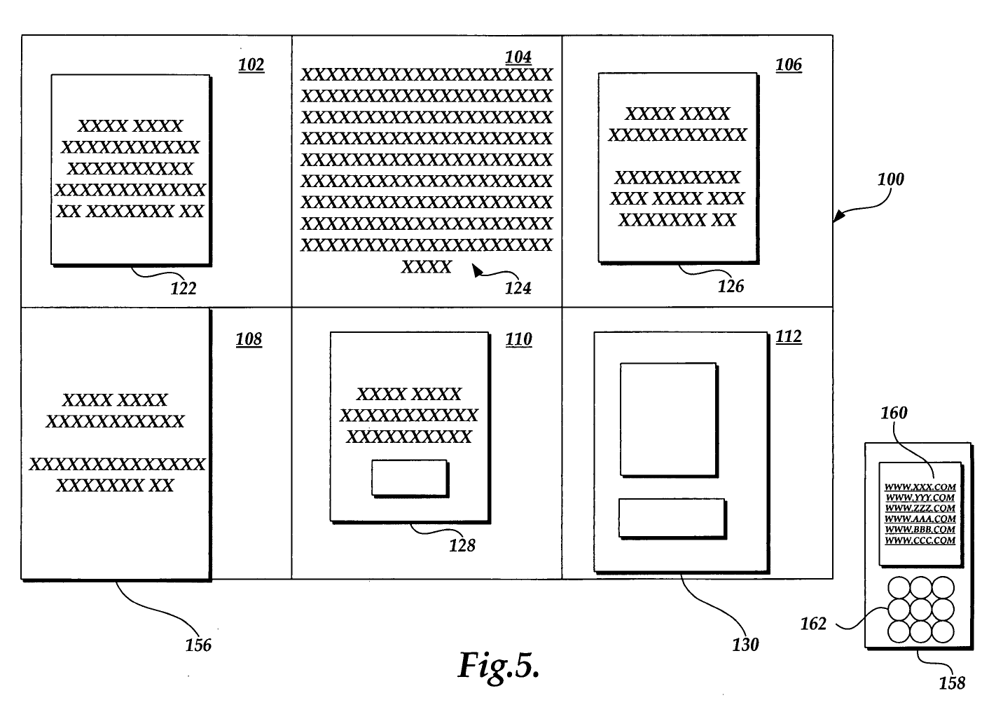

Referring now to FIG. 5, another aspect of the present invention is illustrated. As before, display space 100 includes multiple windows 102, 104, 106, 108, 110, and 112. Each of the windows 102-112 includes content related to a subset of search targets obtained by executing a search tool, for example. However, in this embodiment of the invention, the base search window is not in the display space 100. In this embodiment, the base search window 160 is on a separate computing device, such as a device 158 in communication with a display device corresponding to windows 102-112. The contents associated with the objects in the base search window 160 are displayed in multiple windows in a display space 100 belonging to a different computer system. Content 122 associated with the first (top) search target link in the base search window 160 is provided in the window 102. In an illustrative embodiment, the display space 100 containing the display of content associated with the search targets may be located at a kiosk. As is well known to those of skill in the art, a “kiosk” generally refers to a freestanding computer or terminal that provides information to the general public, usually through a multimedia display. Accordingly, display space 100 may be available to a plurality of users from the general public. Any one of the general public may carry a device, such as mobile phone 158, also having a display 160. Mobile phone 158 also includes controls 162. Although the present invention is described in the context of a mobile phone, the invention is not to be limited to any one particular embodiment. The invention may be used with various computing devices, such as PDAs, hybrid computing devices, and personal computing devices, in which the contents of search result targets generated by a computing device may be displayed onto a larger display space such as at the display space 100. When a user executes a search via a search tool, the results may be displayed as an ordered list in the user's device display 160. However, the content that is associated to each one of the search target links shown in display 160 is more fully displayed in the kiosk display space 100. The user may navigate through the content and search target links through the use of navigational and control buttons on the keypad 162, such as through the use of drag and drop controls, numerical schema, or other visual cues. Additionally, the ordered list does not have to be displayed.

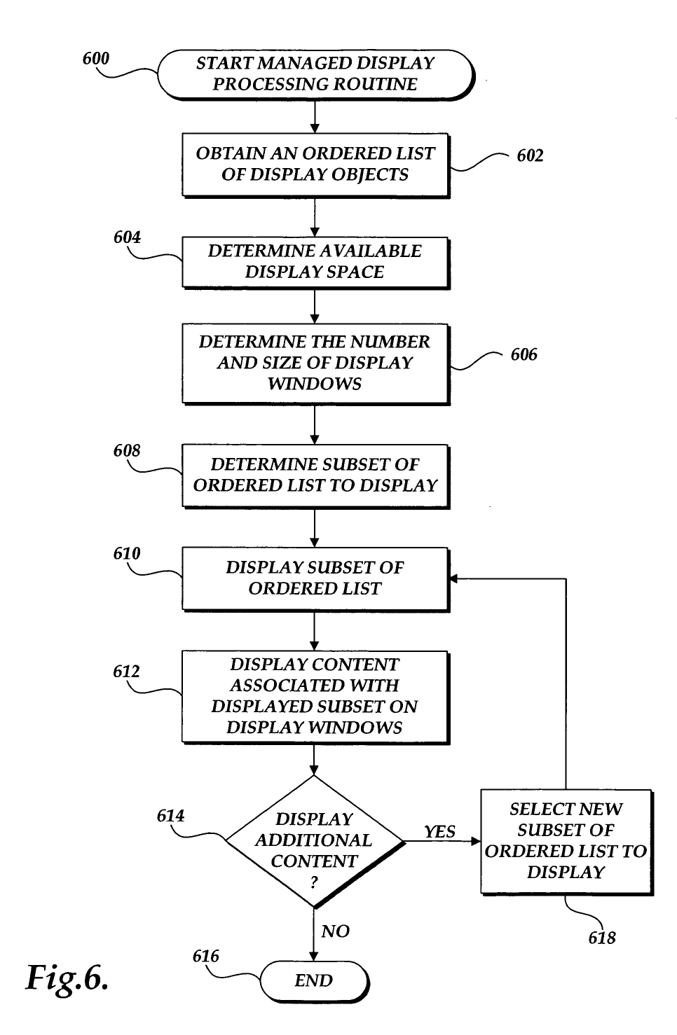

Referring now to FIG. 6, a method for the management of display windows is illustrated. At block 602, the method includes obtaining an ordered list of display objects. As is well known to those skilled in the art, one example of obtaining an ordered list of objects is by executing a search via any number of well known searching tools, such as desktop search tools, and Internet search engines, such as YAHOO®, GOOGLE®, and the like. Although the invention is discussed in the context of searching tools, the invention should not be construed as limited to searching tools. The management of any ordered list of objects may be exercised with the method of the present invention. For example, any list that defines objects, wherein not all the content associated with such objects can be displayed fully on the list, are suitable to be used in the present invention.

At block 604, the method includes determining the available display space. In one example, the total display space may correspond to the size of the physical computer system display. Alternatively, one window may be reserved to be used as a base search window, leaving the remaining display space to be used for the display of content corresponding to the ordered list of objects.

At block 606, the method determines the number and size of display windows for display content associated with the ordered list of display objects. In an illustrative embodiment of the present invention, the number of display windows corresponds to a calculation of the total amount of display area divided by a minimum amount of space for each window. For example, if display area 100 corresponds to a cluster of computer displays, the minimum size of each window may correspond to a single display screen. In another embodiment, the size of the display window corresponds to a calculation of the total display area divided by the minimum number of windows to display.

At block 608, the method determines a subset from the ordered list of objects to display. A search tool may provide search result targets that number in the thousands. Preferably, but not necessarily, the subset of ordered objects that is displayed is limited to a number such that the content of each object in the subset will correspond to a window. For example, the number of ordered objects in the subset may be equal to the number of windows on the display not including the base search window, if there is one. At block 610, the method displays the subset of the ordered list of objects. For example, the ordered list of objects may be confined to the base search window, which is only a fraction of the total available display space. At block 612, the method displays the content that is associated with the displayed subset of objects in a plurality of windows. Each object's content is therefore more fully visible to the user, and the user is relieved of the burden of having to navigate to each object individually to determine the content. The display of content may require an instantiation of one or more software applications, such as browsers, word processing applications, etc., to display the content.

At decision block 614, a test is conducted to determine whether to display additional content. If the method determines that the answer to the test is “YES,” the method enters block 618, wherein a new subset of the ordered list of objects corresponding to the request for additional content is selected. The request to display additional content may come, for example, by either selecting the next page browse button or the previous page browse button. In other embodiments, the request to display additional content may come by selecting a drag and drop control from a basket, as discussed in association with FIG. 3A; by selecting a drag and drop control from a hierarchically arranged list of drag and drop controls, as discussed in association with FIG. 3B; or by selecting a numerical schema, as discussed in association with FIG. 4. Depending on the operation to select additional content, the subset of the ordered list of objects will change so that the ordered list of objects will correspond to the new content. From block 618, the method enters block 610. As discussed above, block 610 displays a subset from a list of ordered objects. Subsequently, the method enters block 612 and block 614 again. In block 612, the method displays the content associated with the displayed subset of objects on display windows and may include replacing the content from the previous subset of objects with the content of the new subset of objects. In block 614, the method continuously checks for a “YES” to the test in block 614. If the answer to the test of block 614 is “NO”, the method terminates at block 616.

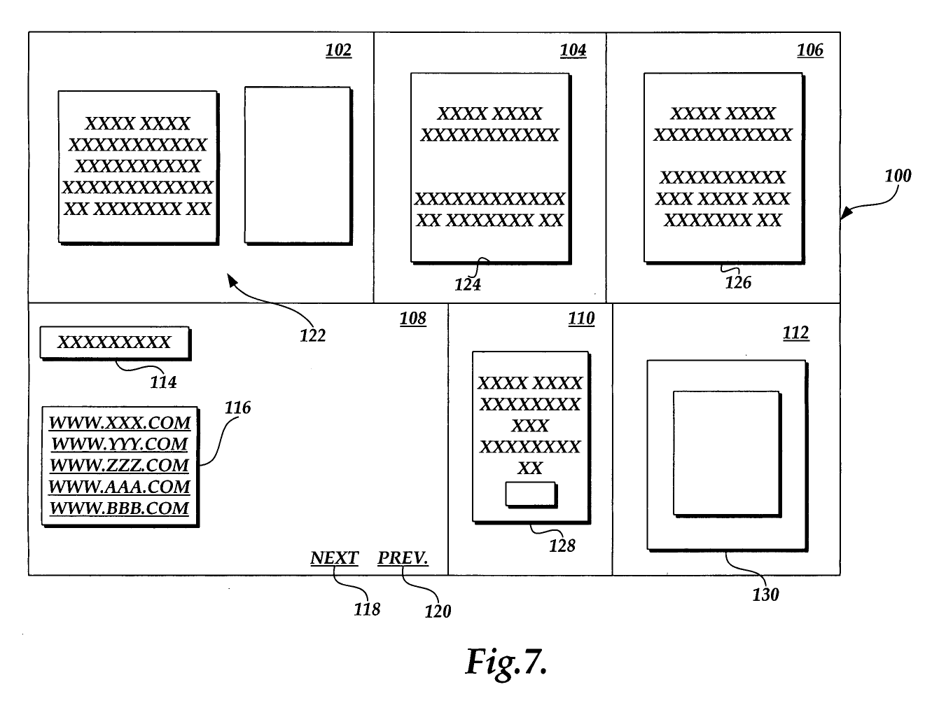

Referring now to FIG. 7, another aspect of the present invention is illustrated. As with the display of FIGS. 1-5, FIG. 7 shows a display space 100 with multiple windows 102, 104, 106, 110, and 112 and a base search window 108. In this aspect of the invention, each of the multiple windows 102, 104, 106, 110, and 112, is independently sized without regard to equal distribution of display space. In one embodiment, a display window may be optimally sized to fit the content associated with each display object. Alternatively, the display window may be sized according to a determined relevance or other user/system specified criteria.

While illustrative embodiments of the invention have been illustrated and described, it will be appreciated that various changes can be made therein without departing from the spirit and scope of the invention.

The embodiments of the invention in which an exclusive property or privilege is: claimed are defined as follows:

1. A method for managing the display of content, the method comprising:
(a) obtaining an ordered list of objects;
(b) displaying at least a subset of the ordered list; and
(c) automatically displaying content associated with the subset of the ordered list in a plurality of display windows corresponding to an available display space.

2. The method of claim 1, further comprising calculating a display window size corresponding to the available display space.

3. The method of claim 1, further comprising:
obtaining a second subset of objects from the ordered list; and
automatically displaying content associated with the second subset of the ordered list in a plurality of display windows corresponding to an available display space.

4. The method of claim 1, wherein at least one display window is sized differently from a second display window.

5. The method of claim 1, wherein automatically displaying content includes displaying a visual cue identifying a display window, the method further comprising:
obtaining a selection of a visual cue; and
saving content associated with the visual cue.

6. The method of claim 5, wherein the visual cue is a drag and drop control.

7. The method of claim 5, wherein the visual cue is a numerical identifier.

8. A method for managing the display of content, the method comprising:
obtaining an ordered list of display objects; and
automatically displaying content associated with a subset of the ordered list in a plurality of display windows corresponding to an available display space.

9. The method of claim 8, wherein automatically displaying content includes displaying a visual cue identifying a display window, the method further comprising:
obtaining a selection of a visual cue; and
saving content associated with the visual cue.

10. The method of claim 9, wherein the visual cue is a drag and drop control.

11. The method of claim 9, wherein the visual cue is a numerical identifier.

12. The method of claim 8, wherein automatically displaying content includes displaying content corresponding to two or more software applications.

13. The method of claim 8, wherein a visual cue identifying a display window is displayed.

14. A search system, comprising:
a search module for obtaining an ordered list of display objects; and
a module for displaying content associated with at least a subset of the ordered list of objects obtained by the search module in a plurality of display windows.

15. The system of claim 14, wherein the module may apportion a display space into a plurality of windows.

16. The system of claim 14, wherein the module may determine the size and number of windows to fit into the display space.

17. The system of claim 14, wherein the module may size a display window to fit the content of an object.

18. The system of claim 14, wherein the module may provide controls to save content.

19. The system of claim 14, wherein a window is provided to display a subset of search result targets.

20. The system of claim 14, wherein the search module and display module correspond to a mobile computing device and wherein the display window corresponds to a kiosk.
